(19) United States
(12) Patent Application Publication
(10) Pub. No.: US 2014/0005082 A1
(43) Pub. Date: Jan. 2, 2014

(54) METHOD AND COMPOSITION FOR ENHANCED HYDROCARBONS RECOVERY FROM A FORMATION CONTAINING A CRUDE OIL

(71) Applicants: Julian Richard Barnes, Amsterdam (NL); James Laurel Buechele, Houston, TX (US); Robert Hardy Ellison, Katy, TX (US); Kirk Herbert Raney, Houston, TX (US); Thomas Carl Semple, Friendswood, TX (US); Johan Paul Smit, Amsterdam (NL)

(72) Inventors: Julian Richard Barnes, Amsterdam (NL); James Laurel Buechele, Houston, TX (US); Robert Hardy Ellison, Katy, TX (US); Kirk Herbert Raney, Houston, TX (US); Thomas Carl Semple, Friendswood, TX (US); Johan Paul Smit, Amsterdam (NL)

(21) Appl. No.: 13/976,537

(22) PCT Filed: Dec. 9, 2011
(86) PCT No.: PCT/US11/64083

§ 371 Date: Sep. 20, 2013

Related U.S. Application Data
(60) Provisional application No. 61/427,922, filed on Dec. 29, 2010.

(51) Int. Cl. C09K 8/584

(52) U.S. Cl. CPC C09K 8/584
USPC 507/254; 507/255; 507/261; 558/34

(57) ABSTRACT

A hydrocarbon recovery composition comprising vinylidene based alkoxylate derivatives. A method of treating a crude oil formation and a method of preparing the hydrocarbon recovery composition are also described.

### FIELD OF THE INVENTION

The present invention generally relates to methods for recovery of hydrocarbons from hydrocarbon-bearing formations. More particularly, embodiments described herein relate to methods of enhanced hydrocarbon recovery and to compositions useful therein.

### BACKGROUND OF THE INVENTION

Hydrocarbons may be recovered from hydrocarbon-bearing formations by penetrating the formation with one or more wells. Hydrocarbons may flow to the surface through the wells. Conditions (e.g., permeability, hydrocarbon concentration, porosity, temperature, pressure, amongst others) of the hydrocarbon containing formation may affect the economic viability of hydrocarbon production from the hydrocarbon containing formation. A hydrocarbon-bearing formation may have natural energy (e.g., gas, water) to aid in mobilizing hydrocarbons to the surface of the hydrocarbon containing formation. Natural energy may be in the form of water. Water may exert pressure to mobilize hydrocarbons to one or more production wells. Gas may be present in the hydrocarbon-bearing formation (reservoir) at sufficient pressures to mobilize hydrocarbons to one or more production wells. The natural energy source may become depleted over time. Supplemental recovery processes may be used to continue recovery of hydrocarbons from the hydrocarbon containing formation. Examples of supplemental processes include waterflooding, polymer flooding, alkali flooding, thermal processes, solution flooding or combinations thereof.

In chemical enhanced oil recovery (EOR) the mobilization of residual oil saturation is achieved through surfactants which generate a sufficiently (ultra) low crude oil/water interfacial tension (IFT) to give a capillary number large enough to overcome capillary forces and allow the oil to flow (I. Chatzis and N. R. Morrows, “Correlation of capillary number relationship for sandstone” SPE Journal, Vol 29, pp 555-562, 1989). However, reservoirs have different characteristics (crude oil type and composition, temperature and the water composition—salinity, hardness) and it is desirable that the structures of added surfactant(s) be matched to these conditions to achieve a low IFT. In addition, a promising surfactant must fulfill other important criteria including low rock retention, compatibility with polymer, thermal and hydrolytic stability and acceptable cost.

Compositions and methods for enhanced hydrocarbons recovery utilizing an alpha olefin sulfate-containing surfactant component are known. U.S. Pat. Nos. 4,488,976 and 4,537,253 describe enhanced oil or recovery compositions containing such a component. Compositions and methods for enhanced hydrocarbons recovery utilizing internal olefin sulfonates are also known. Such a surfactant composition is described in U.S. Pat. No. 4,597,879. The compositions described in the foregoing patents have the disadvantages that brine solubility and divalent ion tolerance are insufficient at certain reservoir conditions.

U.S. Pat. No. 4,979,564 describes the use of internal olefin sulfonates in a method for enhanced oil recovery using low tension viscous water flood. An example of a commercially available material described as being useful was ENORDET IOS 1720, a product of Shell Oil Company identified as a sulfonated C₁₇₋₂₀ internal olefin sodium salt. This material has a low degree of branching. U.S. Pat. No. 5,068,043 describes a petroleum acid soap-containing surfactant system for waterflooding wherein a cosurfactant comprising a C₁₇₋₂₀ or a C₂₀₋₂₄ internal olefin sulfonate was used.

### SUMMARY OF THE INVENTION

The invention provides a hydrocarbon recovery composition comprising a derivative selected from the group consisting of a carboxylate, a sulfate and a glycerol sulfonate of an ethoxylated/propoxylated alcohol where the alcohol is produced by hydroformylation of a vinylidene.

The invention further provides a method of treating a formation containing crude oil, comprising: (a) providing a hydrocarbon recovery composition to at least a portion of the crude oil containing formation, wherein the composition comprises a derivative selected from the group consisting of a carboxylate, a sulfate and a glycerol sulfonate of an ethoxylated/propoxylated alcohol where the alcohol is produced by hydroformylation of a vinylidene; and (b) allowing the composition to interact with hydrocarbons in the crude oil containing formation.

The invention provides a method of preparing a hydrocarbon recovery composition comprising: (a) dimerizing one or more alpha olefins to produce one or more vinylidenes; (b) hydroformylating the one or more vinylidenes to produce an alcohol; (c) ethoxylating and/or propoxylating the alcohol to produce an alkoxylated alcohol; and (d) reacting the alkoxylated alcohol to form an alkoxylate derivative wherein the derivative is selected from the group consisting of a carboxylate, a sulfate and a glycerol sulfonate.

### BRIEF DESCRIPTION OF THE DRAWINGS

FIG. 1 depicts an embodiment of treating a hydrocarbon containing formation.

FIG. 2 depicts an embodiment of treating a hydrocarbon containing formation.

While the invention is susceptible to various modifications and alternative forms, specific embodiments thereof are shown by way of example in the drawings and will herein be described in detail. It should be understood that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Hydrocarbons may be produced from hydrocarbon formations through wells penetrating a hydrocarbon containing formation. “Hydrocarbons” are generally defined as molecules formed primarily of carbon and hydrogen atoms such as oil and natural gas. Hydrocarbons may also include other elements, such as, but not limited to, halogens, metallic elements, nitrogen, oxygen and/or sulfur. Hydrocarbons derived from a hydrocarbon formation may include, but are not limited to, kerogen, bitumen, pyrobitumen, asphaltenes, resins, saturates, naphthenic acids, oils or combinations thereof. Hydrocarbons may be located within or adjacent to mineral matrices within the earth. Matrices may include, but are not limited to, sedimentary rock, sands, silicilytes, carbonates, diatomites and other porous media.

A “formation” includes one or more hydrocarbon containing layers, one or more non-hydrocarbon layers, an overburden and/or an underburden. An “overburden” and/or an “underburden” includes one or more different types of impermeable materials. For example, overburden/underburden may include rock, shale, mudstone, or wet/tight carbonate (i.e., an impermeable carbonate without hydrocarbons). For example, an underburden may contain shale or mudstone. In some cases, the overburden/underburden may be somewhat permeable. For example, an underburden may be composed of a permeable mineral such as sandstone or limestone. In some embodiments, at least a portion of a hydrocarbon containing formation may exist at less than or more than 1000 feet below the earth's surface.

Properties of a hydrocarbon containing formation may affect how hydrocarbons flow through an underburden/overburden to one or more production wells. Properties include, but are not limited to, mineralogy, porosity, permeability, pore size distribution, surface area, salinity or temperature of formation. Overburden/underburden properties in combination with hydrocarbon properties, such as, capillary pressure (static) characteristics and relative permeability (flow) characteristics may affect mobilization of hydrocarbons through the hydrocarbon containing formation.

Permeability of a hydrocarbon containing formation may vary depending on the formation composition. A relatively permeable formation may include heavy hydrocarbons entrained in, for example, sand or carbonate. “Relatively permeable,” as used herein, refers to formations or portions thereof, that have an average permeability of 10 millidarcy or more. “Relatively low permeability” as used herein, refers to formations or portions thereof that have an average permeability of less than about 10 millidarcy. One darcy is equal to about 0.99 square micrometers. An impermeable portion of a formation generally has a permeability of less than about 0.1 millidarcy. In some cases, a portion or all of a hydrocarbon portion of a relatively permeable formation may include predominantly heavy hydrocarbons and/or tar with no supporting mineral grain framework and only floating (or no) mineral matter (e.g., asphalt lakes).

Fluids (e.g., gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. In an embodiment, a first boundary may form between a water layer and underburden. A second boundary may form between a water layer and a hydrocarbon layer. A third boundary may form between hydrocarbons of different densities in a hydrocarbon containing formation. Multiple fluids with multiple boundaries may be present in a hydrocarbon containing formation, in some embodiments. It should be understood that many combinations of boundaries between fluids and between fluids and the overburden/underburden may be present in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult. Quantification of the interactions (e.g., energy level) at the interface of the fluids and/or fluids and overburden/underburden may be useful to predict mobilization of hydrocarbons through the hydrocarbon containing formation.

Quantification of energy required for interactions (e.g., mixing) between fluids within a formation at an interface may be difficult to measure. Quantification of energy levels at an interface between fluids may be determined by generally known techniques (e.g., spinning drop tensionmeter, Langmuir trough). Interaction energy requirements at an interface may be referred to as interfacial tension. “Interfacial tension” as used herein, refers to a surface free energy that exists between two or more fluids that exhibit a boundary. A high interfacial tension value (e.g., greater than about 10 dynes/cm) may indicate the inability of one fluid to mix with a second fluid to form a fluid emulsion. As used herein, an “emulsion” refers to a dispersion of one immiscible fluid into a second fluid by addition of a composition that reduces the interfacial tension between the fluids to achieve stability. The inability of the fluids to mix may be due to high surface interaction energy between the two fluids. Low interfacial tension values (e.g., less than about 1 dyne/cm) may indicate less surface interaction between the two immiscible fluids. Less surface interaction energy between two immiscible fluids may result in the mixing of the two fluids to form an emulsion. Fluids with low interfacial tension values may be mobilized to a well bore due to reduced capillary forces and subsequently produced from a hydrocarbon containing formation.

Fluids in a hydrocarbon containing formation may wet (e.g., adhere to an overburden/underburden or spread onto an overburden/underburden in a hydrocarbon containing formation). As used herein, “wettability” refers to the preference of a fluid to spread on or adhere to a solid surface in a formation in the presence of other fluids. In an embodiment, hydrocarbons may adhere to sandstone in the presence of gas or water. An overburden/underburden that is substantially coated by hydrocarbons may be referred to as “oil wet.” An overburden/underburden may be oil wet due to the presence of polar and/or or surface-active components (e.g., asphaltenes) in the hydrocarbon containing formation. Formation composition (e.g., silica, carbonate or clay) may determine the amount of adsorption of hydrocarbons on the surface of an overburden/underburden. In some embodiments, a porous and/or permeable formation may allow hydrocarbons to more easily wet the overburden/underburden. A substantially oil wet overburden/underburden may inhibit hydrocarbon production from the hydrocarbon containing formation. In certain embodiments, an oil wet portion of a hydrocarbon containing formation may be located at less than or more than 1000 feet below the earth's surface.

A hydrocarbon formation may include water. Water may interact with the surface of the underburden. As used herein, “water wet” refers to the formation of a coat of water on the surface of the overburden/underburden. A water wet overburden/underburden may enhance hydrocarbon production from the formation by preventing hydrocarbons from wetting the overburden/underburden. In certain embodiments, a water wet portion of a hydrocarbon containing formation may include minor amounts of polar and/or surface-active components.

Water in a hydrocarbon containing formation may contain minerals (e.g., minerals containing barium, calcium, or magnesium) and mineral salts (e.g., sodium chloride, potassium chloride, magnesium chloride). Water salinity, pH and/or water hardness of water in a formation may affect recovery of hydrocarbons in a hydrocarbon containing formation. As used herein “salinity” refers to an amount of dissolved solids in water. “Water hardness,” as used herein, refers to a concentration of divalent ions (e.g., calcium, magnesium) in the water. Water salinity and hardness may be determined by generally known methods (e.g., conductivity, titration). As water salinity increases in a hydrocarbon containing formation, interfacial tensions between hydrocarbons and water may be increased and the fluids may become more difficult to produce.

A hydrocarbon containing formation may be selected for treatment based on factors such as, but not limited to, thickness of hydrocarbon containing layers within the formation, assessed liquid production content, location of the formation, salinity content of the formation, temperature of the formation, and depth of hydrocarbon containing layers. Initially, natural formation pressure and temperature may be sufficient to cause hydrocarbons to flow into well bores and out to the surface. Temperatures in a hydrocarbon containing formation may range from about 0° C. to about 300° C. though a typical maximum reservoir temperature for crude oil enhanced oil recovery is about 150° C. The composition of the present invention is particularly advantageous when used at high temperature because the vinylidene based alkoxylate derivative is stable at such temperatures. As hydrocarbons are produced from a hydrocarbon containing formation, pressures and/or temperatures within the formation may decline. Various forms of artificial lift (e.g., pumps, gas injection) and/or heating may be employed to continue to produce hydrocarbons from the hydrocarbon containing formation. Production of desired hydrocarbons from the hydrocarbon containing formation may become uneconomical as hydrocarbons are depleted from the formation.

Mobilization of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. In an embodiment, capillary forces may be overcome by increasing the pressures within a hydrocarbon containing formation. In other embodiments, capillary forces may be overcome by reducing the interfacial tension between fluids in a hydrocarbon containing formation. The ability to reduce the capillary forces in a hydrocarbon containing formation may depend on a number of factors, including, but not limited to, the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (e.g., brine, steam), gases, polymers, monomers or any combinations thereof to the hydrocarbon formation to increase mobilization of hydrocarbons.

In an embodiment, a hydrocarbon containing formation may be treated with a flood of water. A waterflood may include injecting water into a portion of a hydrocarbon containing formation through injections wells. Flooding of at least a portion of the formation may water wet a portion of the hydrocarbon containing formation. The water wet portion of the hydrocarbon containing formation may be pressurized by known methods and a water/hydrocarbon mixture may be collected using one or more production wells. The water layer, however, may not mix with the hydrocarbon layer efficiently. Poor mixing efficiency may be due to a high interfacial tension between the water and hydrocarbons.

Production from a hydrocarbon containing formation may be enhanced by treating the hydrocarbon containing formation with a polymer and/or monomer that may mobilize hydrocarbons to one or more production wells. The polymer and/or monomer may reduce the mobility of the water phase in pores of the hydrocarbon containing formation. The reduction of water mobility may allow the hydrocarbons to be more easily mobilized through the hydrocarbon containing formation. Polymers include, but are not limited to, polyacrylamides, partially hydrolyzed polyacrylamide, polyacrylates, ethylenic copolymers, biopolymers, carboxymethylcellulose, polyvinyl alcohol, polystyrene sulfonates, polyvinylpyrrolidone, AMPS (2-acrylamide-2-methyl propane sulfonate) or combinations thereof. Examples of ethylenic copolymers include copolymers of acrylic acid and acrylamide, acrylic acid and lauryl acrylate, lauryl acrylate and acrylamide. Examples of biopolymers include xanthan gum and guar gum. In some embodiments, polymers may be cross linked in situ in a hydrocarbon containing formation. In other embodiments, polymers may be generated in situ in a hydrocarbon containing formation. Polymers and polymer preparations for use in oil recovery are described in U.S. Pat. No. 6,427,268 to Zhang et al., entitled “Method For Making Hydrophobically Associative Polymers, Methods of Use and Compositions;” U.S. Pat. No. 6,439,308 to Wang, entitled “Foam Drive Method;” U.S. Pat. No. 5,654,261 to Smith, entitled, “Permeability Modifying Composition For Use In Oil Recovery;” U.S. Pat. No. 5,284,206 to Surles et al., entitled “Formation Treating;” U.S. Pat. No. 5,199,490 to Surles et al., entitled “Formation Treating” and U.S. Pat. No. 5,103,909 to Morgenthaler et al., entitled “Profile Control In Enhanced Oil Recovery,” all of which are incorporated by reference herein.

### The Hydrocarbon Recovery Composition

In an embodiment, a hydrocarbon recovery composition may be provided to the hydrocarbon containing formation. In this invention the composition comprises a particular derivative that is derived from vinylidene olefins. Vinylidene olefin based alkoxylate derivatives contain a mixture of branched hydrophobe structures that are chemically suitable for EOR. Branched alcohol derivatives and generally are suited as surfactants for EOR performance since, when correctly matched to the crude oil, they can provide the combination of a) an ultra low oil/water interfacial tension to reduce capillary forces and mobilize residual oil, and b) mitigation of viscous emulsions that would otherwise cause excessive surfactant retention in reservoir rock and loss of mobility control in a surfactant flood. These features of branched alcohol derivatives are described in D. B Levitt et al, “Identification and Evaluation of High Performance EOR Surfactants”. SPE 100089 Surface Phenomena in Enhanced Oil Recovery.

As discussed above in detail, this invention is particularly useful in hydrocarbon containing formations which contain crude oil. The hydrocarbon recovery composition of this invention is designed to produce a satisfactory hydrocarbon recovery composition for these crude oil containing formations and for the brine found in these formations. The preferred composition comprises a carboxylate, sulfate or glycerol sulfonate derivative of an ethoxylated/propoxylated alcohol formed by hydroformylation of a vinylidene olefin.

A vinylidene olefin is an olefin of the general structure of a 2-alkyl-1-alkene. In an embodiment, the hydrocarbon recovery composition may comprise from about 1 to about 75 wt % of the alkoxylate derivative or blend containing it, preferably from about 10 to about 40 wt % and more preferably from about 20 to about 30 wt %. In an embodiment, a hydrocarbon containing composition may be produced from a hydrocarbon containing formation. The hydrocarbon containing composition may include any combination of hydrocarbons, the alkoxylate derivative described above, a solubilizing agent, methane, water, asphaltenes, carbon monoxide, ammonia and other typical components found in hydrocarbon containing formations.

The remainder of the composition may include, but is not limited to, water, low molecular weight alcohols, organic solvents, alkyl sulfonates, aryl sulfonates, brine or combinations thereof. Low molecular weight alcohols include, but are not limited to, methanol, ethanol, propanol, isopropyl alcohol, tert-butyl alcohol, sec-butyl alcohol, butyl alcohol, tert-amyl alcohol or combinations thereof. Organic solvents include, but are not limited to, methyl ethyl ketone, acetone, lower alkyl cellosolves, lower alkyl carbitols or combinations thereof.

### Manufacture of the Hydrocarbon Recovery Composition

The vinylidene olefins that are used to make the vinylidene based alkoxylate derivatives of the present invention may be made by dimerization of alpha olefins. Alpha olefins are defined as an olefin whose double bond is located at a terminal carbon atom. The alpha olefins may include any alpha olefin with from 4 to 18 carbon atoms. The alpha olefins preferably comprise alpha olefins with from 6 to 16 carbon atoms. More preferred alpha olefins have from 6 to 12 carbon atoms.

The dimerization may be carried out with a single alpha olefin or a blend of alpha olefins. When a single alpha olefin is used, it is preferably a C6, C8, C10 or C12 alpha olefin. When a blend of alpha olefins is used, any combination of alpha olefins may be used.

Physical properties of the final product are typically impacted by the starting materials selected, so the use of some alpha olefins will result in more preferred final products. Some examples of possible blends of alpha olefins are C4 with C8; C4 with C10; C4 with C12; C4 with C14; C4 with C16; C6 with C8; C6 with C10; C6 with C12; C6 with C14; C6 with C18; C8 with C10; C8 with C12; C10 with C12; and C12 with C14. Further it is possible to envision a blend of more than two alpha olefins that could be used to produce suitable products.

The process will be described below in respect to using a single alpha olefin, C8, but this process applies equally to the other single alpha olefins and the blends of alpha olefins described above.

The first step of the process is to dimerize 1-octene to produce 2-hexyl-1-decene. The 2-hexyl-1-decene is a vinylidene olefin that may also be referred to as 7-methylene pentadecane. There are a number of processes for carrying out this dimerization; for example, the processes described in U.S. Pat. No. 4,658,078; U.S. Pat. No. 4,973,788; and U.S. Pat. No. 7,129,197, which are herein incorporated by reference. Dimerization using a metallocene catalyst results in a single vinylidene compound being formed. The product may be distilled, if desired, to remove unreacted monomer and any trimer or higher oligomers that may have formed or the product may be directly used in the next step.

The second step of the process is to hydroformylate the 2-hexyl-1-decene to produce an alcohol mixture comprising 8-methyl-hexadecanol, 10-methyl-hexadecanol and 3-hexyl-undecanol. These three compounds that are formed correspond to hydroformylation at any of the three terminal carbon atoms of the vinylidene. Other products may also be formed by the hydroformylation.

The hydroformylation process may be carried out by reaction of the vinylidene with carbon monoxide and hydrogen according to the Shell Hydroformylation process as described in detail in U.S. Pat. No. 3,420,898; U.S. Pat. No. 6,777,579; U.S. Pat. No. 6,960,695; U.S. Pat. No. 7,329,783, the disclosures of which are incorporated by reference. The hydroformylation process may also be carried out as described in U.S. Pat. No. 3,952,068 which is incorporated herein by reference.

The hydroformylation process may be carried out by reaction of the vinylidene with carbon monoxide and hydrogen according to the Oxo process as described in detail in Kirk-Othmer Encyclopedia of Chemical Technology, 4th Edition, Volume 1, pp. 903-8 (1991), Jacqueline I. Kroschwitz, Executive Editor, Wiley-Interscience, New York which is herein incorporated by reference. The most commonly used is the modified Oxo process using a phosphine, phosphate, arsine, or pyridine ligand modified cobalt or rhodium catalyst as described in U.S. Pat. Nos. 3,231,621; 3,239,566; 3,239,569; 3,239,570; 3,239,571; 3,420,898; 3,440,291; 3,448,158; 3,448,157; 3,496,203; 3,496,204; 3,501,515; 3,527,818, the disclosures of which are incorporated herein by reference.

Hydroformylation is a term used in the art to denote the reaction of an olefin with CO and H₂ to produce an aldehyde/alcohol which has one more carbon atom than the reactant olefin. Frequently in the art the term hydroformylation is utilized to cover the aldehyde and the reduction to the alcohol step in total, ie, hydroformylation refers to the production of alcohols from olefins via carbonylation and an aldehyde reduction process. As used herein, hydroformylation refers to the ultimate production of alcohols.

Hydroformylation adds one carbon plus an —OH group, randomly to any one of the terminal carbons in the feedstock. Thus roughly equal percentages of 8-methyl-hexadecanol, 10-methyl-hexadecanol and 3-hexyl-undecanol are produced. In addition, 10-20% of saturated hydrocarbon and alcohols that were hydroformylated on a carbon other than a terminal carbon are typically produced as byproducts.

In another embodiment, two alpha olefins such as C8 and C12 may be dimerized and then hydroformylated. The resulting alcohol mixture will contain structures whose branches are of more similar chain length compared to those from dimerizing C8 or C12 separately. Similar length branches are known to exhibit some advantages for EOR performance. The vinylidene olefin approach to manufacturing the hydrophobe and the selection of alpha olefin to dimerize has two main advantages: a) it enables the end alcohol mixture to be tailored to match particular reservoir conditions, and b) the mixture of alcohol structures formed reduces the tendency for viscous emulsions to form that would otherwise cause surfactant retention and loss of mobility control in a surfactant flood.

The vinylidene-derived alcohols may be ethoxylated and propoxylated by reacting them with ethylene oxide (EO) and propylene oxide (PO) in the presence of an appropriate alkoxylation catalyst. It is preferred that the propoxylation be carried out first followed by the ethoxylation. PO is more like the carbon chain of the derivative molecule when it comes to hydrophilicity and EO is more like the polar end group of the surfactant derivative molecule. The PO assists in solubilizing one end of the surfactant derivative molecule in the oil phase and the EO assists in solubilizing the other end of the surfactant derivative molecule in the water phase. The EO and PO could be added randomly but this would cause loss of control of the transition gradient (oil to water).

The alkoxylation catalyst may be sodium hydroxide which is commonly used commercially for alkoxylating alcohols. The vinylidene-derived alcohols may be ethoxylated and propoxylated using a double metal cyanide catalyst as described in U.S. Pat. No. 6,977,236 which is herein incorporated by reference in its entirety. The vinylidene-derived alcohols may also be ethoxylated and propoxylated using a lanthanum-based or a rare earth metal-based alkoxylation catalyst as described in U.S. Pat. Nos. 5,059,719 and 5,057,627, both of which are herein incorporated by reference in their entirety.

The vinylidene-derived alcohol ethoxylate/propoxylates may be prepared by adding to the vinylidene-derived alcohol or mixture of vinylidene-derived alcohols a calculated amount, for example from about 0.1 percent by weight to about 0.6 percent by weight, of a strong base, typically an alkali metal or alkaline earth metal hydroxide such as sodium hydroxide or potassium hydroxide, which serves as a catalyst for alkoxylation. An amount of ethylene or propylene oxide calculated to provide the desired number of moles of ethylene or propylene oxide per mole of vinylidene-derived alcohol is then introduced and the resulting mixture is allowed to react until the propylene oxide is consumed. Suitable reaction temperatures range from about 120 to about 220° C.

The vinylidene-derived alcohol ethoxylate/propoxylates of the present invention may be prepared by using a multi-metal cyanide catalyst as the alkoxylation catalyst. The catalyst may be contacted with the vinylidene-derived alcohol and then both may be contacted with the ethylene or propylene oxide reactant which may be introduced in gaseous form. The reaction temperature may range from about 90° C. to about 250° C. and super atmospheric pressures may be used if it is desired to maintain the vinylidene-derived alcohol substantially in the liquid state.

Narrow range vinylidene-derived alcohol ethoxylate/propoxylates may be produced utilizing a soluble basic compound of elements in the lanthanum series elements or the rare earth elements as the alkoxylation catalyst. Lanthanum phosphate is particularly useful. The ethoxylation and propoxylation are carried out employing conventional reaction conditions such as those described above.

It should be understood that the alkoxylation procedure serves to introduce a desired average number of propylene oxide units per mole of primary alcohol ethoxylate/propoxylate. For example, treatment of a vinylidene-derived alcohol mixture with 1.5 moles of propylene oxide per mole of vinylidene-derived alcohol serves to effect the propoxylation of each alcohol molecule with an average of 1.5 propylene oxide moieties per mole of vinylidene-derived alcohol moiety, although a substantial proportion of vinylidene-derived alcohol moieties will have become combined with more than 1.5 propylene oxide moieties and an approximately equal proportion will have become combined with less than 1.5. In a typical alkoxylation product mixture, there is also a minor proportion of unreacted vinylidene-derived alcohol.

In one embodiment, a glycerol sulfonate is prepared. In the preparation of the glycerol sulfonates derived from the alkoxylated primary alcohols of the present invention, the alkoxylates are reacted with epichlorohydrin, preferably in the presence of a catalyst such as tin tetrachloride at from about 110 to about 120° C. for from about 3 to about 5 hours at a pressure of about 14.7 to about 15.7 psia (about 100 to about 110 kPa) in toluene. Next, the reaction product is reacted with a base such as sodium hydroxide or potassium hydroxide at from about 85 to about 95° C. for from about 2 to about 4 hours at a pressure of about 14.7 to about 15.7 psia (about 100 to about 110 kPa). The reaction mixture is cooled and separated in two layers. The organic layer is separated and the product isolated. It is then reacted with sodium bisulfite and sodium sulfite at from about 140 to about 160° C. for from about 3 to about 5 hours at a pressure of about 60 to about 80 psia (about 400 to about 550 kPa). The reaction is cooled and the product glycerol sulfonate is recovered as about a 25 wt % active matter solution in water. The reactor is preferably a 500 ml zipperclave reactor.

In another embodiment, sulfates are prepared. The primary alcohol alkoxylates may be sulfated using one of a number of sulfating agents including sulfur trioxide, complexes of sulfur trioxide with (Lewis) bases, such as the sulfur trioxide pyridine complex and the sulfur trioxide trimethylamine complex, chlorosulfonic acid and sulfamic acid. The sulfation may be carried out at a temperature preferably not above about 80° C. The sulfation may be carried out at temperature as low as about −20° C., but higher temperatures are more economical. For example, the sulfation may be carried out at a temperature from about 20 to about 70° C., preferably from about 20 to about 60° C., and more preferably from about 20 to about 50° C. Sulfur trioxide is the most economical sulfating agent.

The primary alcohol alkoxylates may be reacted with a gas mixture which in addition to at least one inert gas contains from about 1 to about 8 percent by volume, relative to the gas mixture, of gaseous sulfur trioxide, preferably from about 1.5 to about 5 percent volume. In principle, it is possible to use gas mixtures having less than 1 percent by volume of sulfur trioxide but the space-time yield is then decreased unnecessarily. Inert gas mixtures having more than 8 percent by volume of sulfur trioxide in general may lead to difficulties due to uneven sulfation, lack of consistent temperature and increasing formation of undesired byproducts. Although other inert gases are also suitable, air or nitrogen are preferred, as a rule because of easy availability.

The reaction of the primary alcohol alkoxylate with the sulfur trioxide containing inert gas may be carried out in falling film reactors. Such reactors utilize a liquid film trickling in a thin layer on a cooled wall which is brought into contact in a continuous current with the gas. Kettle cascades, for example, would be suitable as possible reactors. Other reactors include stirred tank reactors, which may be employed if the sulfation is carried out using sulfamic acid or a complex of sulfur trioxide and a (Lewis) base, such as the sulfur trioxide pyridine complex or the sulfur trioxide trimethylamine complex. These sulfation agents would allow an increased residence time of sulfation without the risk of ethoxylate chain degradation and olefin elimination by (Lewis) acid catalysis.

The molar ratio of sulfur trioxide to alkoxylate may be 1.4 to 1 or less including about 0.8 to about 1 mole of sulfur trioxide used per mole of OH groups in the alkoxylate and latter ratio is preferred. Sulfur trioxide may be used to sulfate the alkoxylates and the temperature may range from about −20° C. to about 50° C., preferably from about 5° C. to about 40° C., and the pressure may be in the range from about 100 to about 500 kPa abs. The reaction may be carried out continuously or discontinuously. The residence time for sulfation may range from about 0.5 seconds to about 10 hours, but is preferably from 0.5 seconds to 20 minutes.

The sulfation may be carried out using chlorosulfonic acid at a temperature from about −20° C. to about 50° C., preferably from about 0° C. to about 30° C. The mole ratio between the alkoxylate and the chlorosulfonic acid may range from about 1:0.8 to about 1:1.2, preferably about 1:0.8 to 1:1. The reaction may be carried out continuously or discontinuously for a time between fractions of seconds (i.e., 0.5 seconds) to about 20 minutes.

Unless they are only used to generate gaseous sulfur trioxide to be used in sulfation, the use of sulfuric acid and oleum should be omitted. Subjecting any ethoxylate to these reagents leads to ether bond breaking—expulsion of 1,4-dioxane (back-biting)—and finally conversion of primary alcohol to an internal olefin.

Following sulfation, the liquid reaction mixture may be neutralized using an aqueous alkali metal hydroxide, such as sodium hydroxide or potassium hydroxide, an aqueous alkaline earth metal hydroxide, such as magnesium hydroxide or calcium hydroxide, or bases such as ammonium hydroxide, substituted ammonium hydroxide, sodium carbonate or potassium hydrogen carbonate. The neutralization procedure may be carried out over a wide range of temperatures and pressures. For example, the neutralization procedure may be carried out at a temperature from about 0° C. to about 65° C. and a pressure in the range from about 100 to about 200 kPa abs. The neutralization time may be in the range from about 0.5 hours to about 1 hour but shorter and longer times may be used where appropriate.

In another embodiment carboxylates are prepared. The ethoxylated/propoxylated branched vinylidene-derived alcohol of this invention may be carboxylated by any of a number of well-known methods. It may be reacted with a halogenated carboxylic acid to make a carboxylic acid. Alternatively, the alcoholic end group—CH₂OH—may be oxidized to yield a carboxylic acid. In either case, the resulting carboxylic acid may then be neutralized with an alkali metal base to form a carboxylate surfactant.

In a specific example, an ethoxylated/propoxylated vinylidene-derived alcohol may be reacted with potassium t-butoxide and initially heated at, for example, 60° C. under reduced pressure for, for example, 10 hours. It would be allowed to cool and then sodium chloroacetate would be added to the mixture. The reaction temperature would be increased to, for example, 90° C. under reduced pressure for, for example, 20-21 hours. It would be cooled to room temperature and water and hydrochloric acid added. This would be heated to, for example, 90° C. for, for example, 2 hours. The organic layer may be extracted by adding ethyl acetate and washing it with water.

### Injection of the Hydrocarbon Recovery Composition

The hydrocarbon recovery composition may interact with hydrocarbons in at least a portion of the hydrocarbon containing formation. Interaction with the hydrocarbons may reduce an interfacial tension of the hydrocarbons with one or more fluids in the hydrocarbon containing formation. In other embodiments, a hydrocarbon recovery composition may reduce the interfacial tension between the hydrocarbons and an overburden/underburden of a hydrocarbon containing formation. Reduction of the interfacial tension may allow at least a portion of the hydrocarbons to mobilize through the hydrocarbon containing formation.

The ability of a hydrocarbon recovery composition to reduce the interfacial tension of a mixture of hydrocarbons and fluids may be evaluated using known techniques. In an embodiment, an interfacial tension value for a mixture of hydrocarbons and water may be determined using a spinning drop tensionmeter.

Due to the well-established relationship between micro-emulsion phase behavior and IFT, it is common in the industry to screen surfactants and their formulations for low IFT behavior through laboratory-based oil/water phase behavior tests, for example this is as described in “D. B Levitt et al, “Identification and Evaluation of High Performance EOR Surfactants”. SPE 100089 Surface Phenomena in Enhanced Oil Recovery”. In micro-emulsion phase tests the optimal salinity is the point where equal amounts of oil and water are solubilised in the middle phase microemulsion, known as Winsor type III. The oil solubilisation parameter is the ratio of oil volume (Vo) to neat surfactant volume (Vs) and the water solubilisation ratio is the ratio of water volume (Vw) to neat surfactant volume (Vs). The intersection of Vo/Vs and Vw/Vs as salinity is varied defines a) the optimal salinity, and b) the solubilisation parameter at the optimal salinity. It has been established by Huh that IFT is inversely proportional to the square of the solubilsation parameter (as described in: C. Huh, “Interfacial tensions and solubilizing ability of a microemulsion phase that coexists with oil and brine, Journal of Colloid and Interface Science, September 1979, pp 408-426”). When the solubilisation parameter is 10 or higher, the IFT at the optimal salinity is <0.003 dyne/cm which is required to mobilise residual oil via surfactant EOR. Thus the target solubilisation parameter for our surfactant screening is 10 or greater with the higher the value the more “active” the surfactant.

As well from as indicating where ultra low IFTs are achieved the microemulsion phase test provides extra qualitative information that is relevant to a surfactant flood. This includes the relative viscosity of phases, wetting behaviour, the presence of undesirable macroemulsions or gels and the time for the phases to equilibrate (fast equilibration indicating a more promising system).

An amount of the hydrocarbon recovery composition may be added to the hydrocarbon/water mixture and an interfacial tension value for the resulting fluid may be determined. A low interfacial tension value (e.g., less than about 1 dyne/cm) may indicate that the composition reduced at least a portion of the surface energy between the hydrocarbons and water. Reduction of surface energy may indicate that at least a portion of the hydrocarbon/water mixture may mobilize through at least a portion of a hydrocarbon containing formation.

In an embodiment, a hydrocarbon recovery composition may be added to a hydrocarbon/water mixture and the interfacial tension value may be determined. Preferably, the interfacial tension is less than about 0.1 dyne/cm. An ultralow interfacial tension value (e.g., less than about 0.01 dyne/cm) may indicate that the hydrocarbon recovery composition lowered at least a portion of the surface tension between the hydrocarbons and water such that at least a portion of the hydrocarbons may mobilize through at least a portion of the hydrocarbon containing formation. At least a portion of the hydrocarbons may mobilize more easily through at least a portion of the hydrocarbon containing formation at an ultra low interfacial tension than hydrocarbons that have been treated with a composition that results in an interfacial tension value greater than 0.01 dynes/cm for the fluids in the formation. Addition of a hydrocarbon recovery composition to fluids in a hydrocarbon containing formation that results in an ultra-low interfacial tension value may increase the efficiency at which hydrocarbons may be produced. A hydrocarbon recovery composition concentration in the hydrocarbon containing formation may be minimized to minimize cost of use during production.

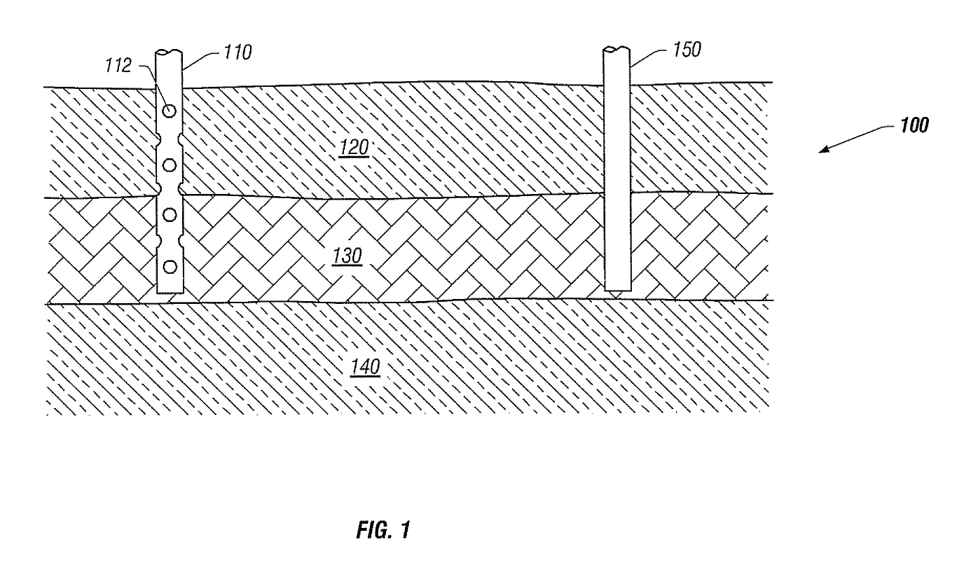

In an embodiment of a method to treat a hydrocarbon containing formation, a hydrocarbon recovery composition including a vinylidene based alkoxylate derivative may be provided (e.g., injected) into hydrocarbon containing formation 100 through injection well 110 as depicted in FIG. 1. Hydrocarbon formation 100 may include overburden 120, hydrocarbon layer 130, and underburden 140. Injection well 110 may include openings 112 that allow fluids to flow through hydrocarbon containing formation 100 at various depth levels. In certain embodiments, hydrocarbon layer 130 may be less than 1000 feet below earth's surface. In some embodiments, underburden 140 of hydrocarbon containing formation 100 may be oil wet. Low salinity water may be present in hydrocarbon containing formation 100, in other embodiments.

A hydrocarbon recovery composition may be provided to the formation in an amount based on hydrocarbons present in a hydrocarbon containing formation. The amount of hydrocarbon recovery composition, however, may be too small to be accurately delivered to the hydrocarbon containing formation using known delivery techniques (e.g., pumps). To facilitate delivery of small amounts of the hydrocarbon recovery composition to the hydrocarbon containing formation, the hydrocarbon recovery composition may be combined with water and/or brine to produce an injectable fluid.

In an embodiment, the hydrocarbon recovery composition is provided to the formation containing crude oil with heavy components by admixing it with brine from the formation from which hydrocarbons are to be extracted or with fresh water. The mixture is then injected into the hydrocarbon containing formation.

In an embodiment, the hydrocarbon recovery composition is provided to a hydrocarbon containing formation 100 by admixing it with brine from the formation. Preferably, the hydrocarbon recovery composition comprises from about 0.01 to about 2.00 wt % of the total water and/or brine/hydrocarbon recovery composition mixture (the injectable fluid). More important is the amount of actual active matter that is present in the injectable fluid (active matter is the surfactant, here the vinylidene based alkoxylate derivative or the blend containing it). Thus, the amount of the vinylidene based alkoxylate derivative in the injectable fluid may be from about 0.05 to about 1.0 wt %, preferably from about 0.1 to about 0.8 wt %. More than 1.0 wt % could be used but this would likely increase the cost without enhancing the performance. The injectable fluid is then injected into the hydrocarbon containing formation.

The vinylidene based alkoxylate derivative may be used without a co-surfactant and/or a solvent. The vinylidene based alkoxylate derivative may not perform optimally by itself for certain crude oils. Co-surfactants and/or co-solvents may be added to the hydrocarbon recovery composition to enhance the activity.

The hydrocarbon recovery composition may interact with at least a portion of the hydrocarbons in hydrocarbon layer 130. The interaction of the hydrocarbon recovery composition with hydrocarbon layer 130 may reduce at least a portion of the interfacial tension between different hydrocarbons. The hydrocarbon recovery composition may also reduce at least a portion of the interfacial tension between one or more fluids (e.g., water, hydrocarbons) in the formation and the underburden 140, one or more fluids in the formation and the overburden 120 or combinations thereof.

In an embodiment, a hydrocarbon recovery composition may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. An interfacial tension value between the hydrocarbons and one or more fluids may be altered by the hydrocarbon recovery composition to a value of less than about 0.1 dyne/cm. In some embodiments, an interfacial tension value between the hydrocarbons and other fluids in a formation may be reduced by the hydrocarbon recovery composition to be less than about 0.05 dyne/cm. An interfacial tension value between hydrocarbons and other fluids in a formation may be lowered by the hydrocarbon recovery composition to less than 0.001 dyne/cm, in other embodiments.

At least a portion of the hydrocarbon recovery composition/hydrocarbon/fluids mixture may be mobilized to production well 150. Products obtained from the production well 150 may include, but are not limited to, components of the hydrocarbon recovery composition (e.g., a long chain aliphatic alcohol and/or a long chain aliphatic acid salt), methane, carbon monoxide, water, hydrocarbons, ammonia, or combinations thereof. Hydrocarbon production from hydrocarbon containing formation 100 may be increased by greater than about 50% after the hydrocarbon recovery composition has been added to a hydrocarbon containing formation.

In certain embodiments, hydrocarbon containing formation 100 may be pretreated with a hydrocarbon removal fluid. A hydrocarbon removal fluid may be composed of water, steam, brine, gas, liquid polymers, foam polymers, monomers or mixtures thereof. A hydrocarbon removal fluid may be used to treat a formation before a hydrocarbon recovery composition is provided to the formation. Hydrocarbon containing formation 100 may be less than 1000 feet below the earth's surface, in some embodiments. A hydrocarbon removal fluid may be heated before injection into a hydrocarbon containing formation 100, in certain embodiments. A hydrocarbon removal fluid may reduce a viscosity of at least a portion of the hydrocarbons within the formation. Reduction of the viscosity of at least a portion of the hydrocarbons in the formation may enhance mobilization of at least a portion of the hydrocarbons to production well 150. After at least a portion of the hydrocarbons in hydrocarbon containing formation 100 have been mobilized, repeated injection of the same or different hydrocarbon removal fluids may become less effective in mobilizing hydrocarbons through the hydrocarbon containing formation. Low efficiency of mobilization may be due to hydrocarbon removal fluids creating more permeable zones in hydrocarbon containing formation 100. Hydrocarbon removal fluids may pass through the permeable zones in the hydrocarbon containing formation 100 and not interact with and mobilize the remaining hydrocarbons. Consequently, displacement of heavier hydrocarbons adsorbed to underburden 140 may be reduced over time. Eventually, the formation may be considered low producing or economically undesirable to produce hydrocarbons.

In certain embodiments, injection of a hydrocarbon recovery composition after treating the hydrocarbon containing formation with a hydrocarbon removal fluid may enhance mobilization of heavier hydrocarbons absorbed to underburden 140. The hydrocarbon recovery composition may interact with the hydrocarbons to reduce an interfacial tension between the hydrocarbons and underburden 140. Reduction of the interfacial tension may be such that hydrocarbons are mobilized to and produced from production well 150. Produced hydrocarbons from production well 150 may include, in some embodiments, at least a portion of the components of the hydrocarbon recovery composition, the hydrocarbon removal fluid injected into the well for pretreatment, methane, carbon dioxide, ammonia, or combinations thereof. Adding the hydrocarbon recovery composition to at least a portion of a low producing hydrocarbon containing formation may extend the production life of the hydrocarbon containing formation. Hydrocarbon production from hydrocarbon containing formation 100 may be increased by greater than about 50% after the hydrocarbon recovery composition has been added to hydrocarbon containing formation. Increased hydrocarbon production may increase the economic viability of the hydrocarbon containing formation.

Interaction of the hydrocarbon recovery composition with at least a portion of hydrocarbons in the formation may reduce at least a portion of an interfacial tension between the hydrocarbons and underburden 140. Reduction of at least a portion of the interfacial tension may mobilize at least a portion of hydrocarbons through hydrocarbon containing formation 100. Mobilization of at least a portion of hydrocarbons, however, may not be at an economically viable rate.

In one embodiment, polymers and/or monomers may be injected into hydrocarbon formation 100 through injection well 110, after treatment of the formation with a hydrocarbon recovery composition, to increase mobilization of at least a portion of the hydrocarbons through the formation. Suitable polymers include, but are not limited to, CIBA® ALCOFLOOD®, manufactured by Ciba Specialty Additives (Tarrytown, N.Y.), Tramfloc® manufactured by Tramfloc Inc. (Temple, Ariz.), and HE® polymers manufactured by Chevron Phillips Chemical Co. (The Woodlands, Tex.). Interaction between the hydrocarbons, the hydrocarbon recovery composition and the polymer may increase mobilization of at least a portion of the hydrocarbons remaining in the formation to production well 150.

The vinylidene based alkoxylate derivative of the composition is thermally stable and may be used over a wide range of temperature. The hydrocarbon recovery composition may be added to a portion of a hydrocarbon containing formation 100 that has an average temperature of above about 70° C. because of the high thermal stability of the vinylidene based alkoxylate derivative.

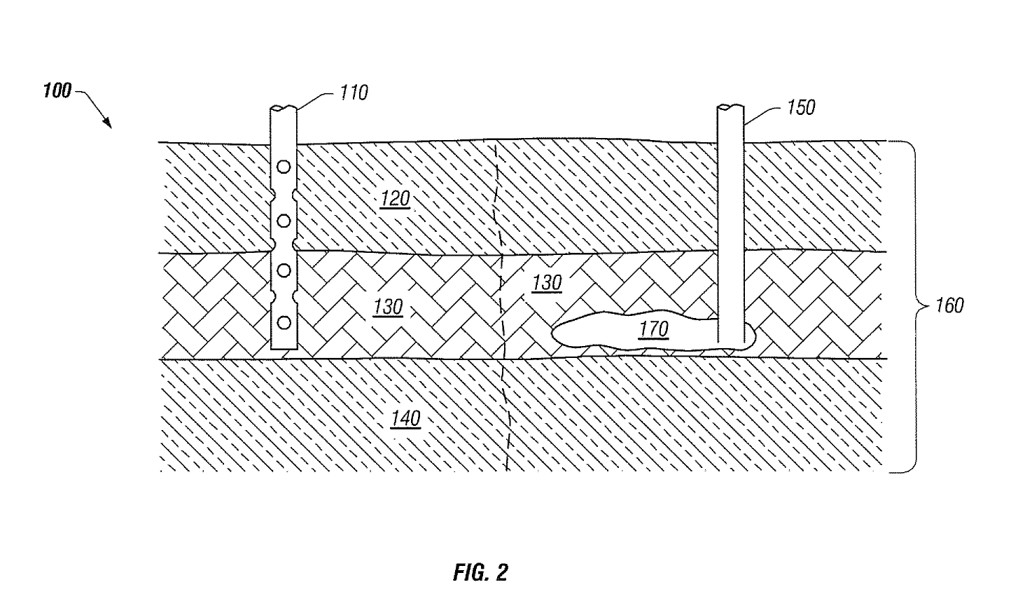

In some embodiments, a hydrocarbon recovery composition may be combined with at least a portion of a hydrocarbon removal fluid (e.g. water, polymer solutions) to produce an injectable fluid. The hydrocarbon recovery composition may be injected into hydrocarbon containing formation 100 through injection well 110 as depicted in FIG. 2. Interaction of the hydrocarbon recovery composition with hydrocarbons in the formation may reduce at least a portion of an interfacial tension between the hydrocarbons and underburden 140. Reduction of at least a portion of the interfacial tension may mobilize at least a portion of hydrocarbons to a selected section 160 in hydrocarbon containing formation 100 to form hydrocarbon pool 170. At least a portion of the hydrocarbons may be produced from hydrocarbon pool 170 in the selected section of hydrocarbon containing formation 100.

In other embodiments, mobilization of at least a portion of hydrocarbons to selected section 160 may not be at an economically viable rate. Polymers may be injected into hydrocarbon formation 100 to increase mobilization of at least a portion of the hydrocarbons through the formation. Interaction between at least a portion of the hydrocarbons, the hydrocarbon recovery composition and the polymers may increase mobilization of at least a portion of the hydrocarbons to production well 150.

In some embodiments, a hydrocarbon recovery composition may include an inorganic salt (e.g. sodium carbonate (Na₂CO₃), sodium hydroxide, sodium chloride (NaCl), or calcium chloride (CaCl₂)). The addition of the inorganic salt may help the hydrocarbon recovery composition disperse throughout a hydrocarbon/water mixture. The enhanced dispersion of the hydrocarbon recovery composition may decrease the interactions between the hydrocarbon and water interface. The use of an alkali (e.g., sodium carbonate, sodium hydroxide) may prevent adsorption of the vinylidene based alkoxylate derivative onto the rock surface and may create natural surfactants with components in the crude oil. The decreased interaction may lower the interfacial tension of the mixture and provide a fluid that is more mobile. The alkali may be added in an amount of from about 0.1 to 2 wt %.

Under the temperature and pressure conditions in the reservoir, a vinylidene based alkoxylate derivative is soluble and is effective in lowering the IFT. However, conditions above ground where the injectable fluid composition is prepared are different, i.e., lower temperature and pressure. Under such conditions the vinylidene based alkoxylate derivative may not be completely soluble in the injected brine above a certain salt concentration. Before the injectable fluid can be injected, at least a significant portion of the vinylidene based alkoxylate derivative may phase separate out of the mixture. Any portion of the surfactant that is not in solution, i.e. that remains insoluble and forms a precipitate, would eventually plug the porous formation around the wellbore. The result would be that the injection well would plug, with the consequent loss of the ability to inject the fluid. Remedial treatments would have to be done to the well to put it back in function with the consequent loss of time and expense. It would be advantageous if a means could be found to keep the vinylidene based alkoxylate derivative in solution in the injectable fluid as it is injected.

One method to improve the solubility of the vinylidene based alkoxylate derivative is to use combinations of alpha olefins to prepare vinylidene based alkoxylate derivatives of varying carbon tail lengths. This embodiment has been described above. For a particular average molecular weight, the more varied mixture of chemical structures would generally provide improved aqueous solubility versus a product derived from a single alpha olefin source. Another method is to add a minor amount of a solubilizer consisting of internal olefin sulfonate or some other highly-soluble surfactant. Another method is to modify the vinylidene based alkoxylate derivative by increasing the ethylene oxide block in the molecule which will make the molecule more hydrophilic and more water soluble.

The invention provides a method of injecting a hydrocarbon recovery composition comprising a vinylidene based alkoxylate derivative into a hydrocarbon containing formation which comprises: (a) making a solubilized vinylidene based alkoxylate derivative hydrocarbon recovery composition fluid by mixing a major portion of a vinylidene based alkoxylate derivative in fresh water or water having a brine salinity of less than about 2 wt % at a temperature of 50° C. or lower and adding to the mixture a minor amount of a solubilizer which comprises a C₁₅₋₁₈ internal olefin sulfonate or a C₁₉₋₂₃ internal olefin sulfonate or mixtures thereof; and (b) injecting the solubilized vinylidene based alkoxylate derivative hydrocarbon recovery composition into the hydrocarbon containing formation. The weight ratio of the solubilizer to the vinylidene based alkoxylate derivative may be from about 10:90 to about 90:10.

Divalent ions such as calcium and magnesium are commonly present in reservoir brine. Vinylidene based alkoxylate derivatives with sulfate and sulfonate end groups will have a high tolerance to these up to and beyond the concentrations present in sea water. “Divalents tolerance” means that the surfactants will have little tendency to precipitate out of aqueous solution in the presence of divalents. The carboxylate family will have less tolerance. The use of mixed alpha olefins for manufacturing the alcohol hydrophobe (as already mentioned) and the use of mixed surfactant systems, such as a formulation with internal olefin sulfonate solubilizers, will improve the ability of the vinylidene based alkoxylate derivatives to remain in solution containing high levels of divalent ions.

### EXAMPLES

### Example 1

In this example, a C17 vinylidene based alcohol—7PO—sulfate molecule (derived from dimerising a C8 alpha olefin) was prepared and tested to determine its performance as a surfactant for chemical enhanced oil recovery purposes. A microemulsion phase test was carried out at 50° C. using aqueous solutions—containing the test surfactant at 2% active concentration and with different sodium chloride concentrations—and the alkane n-octane. The optimal salinity and associated solubilization ratio were determined. The alkane n-alkane simulates a relatively light crude oil, one with an Equivalent Alkane Carbon Number of 8. Additionally, comparative tests were carried out on a methyl branched C16, 17 alcohol—7PO—sulfate molecule. This molecule is known to have excellent EOR performance (e.g. refer to the paper: D. B Levitt et al, “Identification and Evaluation of High Performance EOR Surfactants”. SPE 100089). The molecular structure of this alcohol hydrophobe is different from that of the vinylidene based molecule, having an exclusively methyl branched structure where between one and two methyl groups are randomly positioned along the carbon chain.

The tests were carried out without a co-solvent being present, this component often used to speed up phase behavior performance and prevent the formation of viscous phases. The C17 vinylidene based alcohol—7PO—sulfate and methyl branched C16, 17 alcohol—7PO—sulfate exhibited Winsor Type III micro-emulsion behavior, confirmed by swaying the tubes around the estimated optimal salinities, showing them to have potentially good EOR performance. The two molecules gave similar optimal salinities, in the range of 1.0-3.0%, and comparable solubilisation ratios though the latter were difficult to quantify since diffuse phases were obtained making measurement of the middle phase volumes problematic. The C17 vinylidene based molecule gave low viscosity phases at different salinities whereas the C16, 17 alcohol based molecule tended to give viscous phases at salinities above the optimum salinity suggesting this molecule was more poorly matched to the alkane n-octane. Further tests with different alkanes could explore this aspect.

The aqueous solubilities of C17 vinylidene based and C16, 17 alcohol based sulfates were similar and good in saline solutions up to the optimal salinity of around 2%. Clear aqueous solutions were observed at ambient temperature and at 50° C. with no signs of phase separation and precipitation. However, at higher salinities (above 3%) two liquid phases formed for the C16, 17 alcohol based sulfate molecule. In contrast, the C17 vinylidene based molecule was slightly more soluble giving a turbid solution with no phase separation.

Concerning physical properties of the two manufactured surfactants, the C17 vinylidene based sulfate was a clear, fluid and single phase product at 36% active whereas the C16, 17 alcohol based sulfate manufactured at 31% was slightly turbid and more viscous. Thus the C17 vinylidene based sulfate appears to have some advantages for product homogeneity with time and pumpability.

1. A hydrocarbon recovery composition comprising a derivative selected from the group consisting of a carboxylate, a sulfate and a glycerol sulfonate of an ethoxylated/propoxylated alcohol where the alcohol is produced by hydroformylation of a vinylidene.

2. A hydrocarbon recovery composition as claimed in claim 1 wherein the vinylidene has a carbon number of from 12 to 32.

3. A hydrocarbon recovery composition as claimed in claim 1 wherein the vinylidene has a carbon number of from 16 to 24.

4. A hydrocarbon recovery composition as claimed in claim 1 comprising at least 10 wt % of the carboxylate, sulfate or glycerol sulfonate derivative.

5. A hydrocarbon recovery composition as claimed in claim 1 comprising of from 1 wt % to 75 wt % of the carboxylate, sulfate or glycerol sulfonate derivative.

6. A method of treating a formation containing crude oil, comprising:
(a) providing a hydrocarbon recovery composition to at least a portion of the crude oil containing formation, wherein the composition comprises a derivative selected from the group consisting of a carboxylate, a sulfate and a glycerol sulfonate of an ethoxylated/propoxylated alcohol where the alcohol is produced by hydroformylation of a vinylidene; and
(b) allowing the composition to interact with hydrocarbons in the crude oil containing formation.

7. The method of claim 6 wherein the hydrocarbon recovery composition is provided to the crude oil containing formation by first admixing it with water and/or brine from the formation from which crude oil is to be extracted to form an injectable fluid, wherein the carboxylate, sulfate or glycerol sulfonate derivative comprises from 0.05 to 1.0 wt % of the injectable fluid, and then injecting the injectable fluid into the formation.

8. A method of preparing a hydrocarbon recovery composition comprising:
(a) dimerizing one or more alpha olefins to produce one or more vinylidenes;
(b) hydroformylating the one or more vinylidenes to produce an alcohol;
(c) ethoxylating and/or propoxylating the alcohol to produce an alkoxylated alcohol; and
(d) reacting the alkoxylated alcohol to form an alkoxylate derivative wherein the derivative is selected from the group consisting of a carboxylate, a sulfate and a glycerol sulfonate.

9. A method as claimed in claim 8 further comprising adding additional components to the alkoxylate derivative.
